(19) United States
(12) Patent Application Publication
(10) Pub. No.: US 2005/0158600 A1
(43) Pub. Date: Jul. 21, 2005

(54) Liquid fuel supply mechanism and fuel cell using the same

(75) Inventors: Tetsuya Mitsuishi, Fukushima-ken (JP); Kazuyoshi Yamagata, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/033,568

(22) Filed: Jan. 11, 2005

(30) Foreign Application Priority Data
Jan. 16, 2004 (JP) 2004-009557

(51) Int. Cl. H01M 8/04

(52) U.S. Cl. 429/26; 429/34

(57) ABSTRACT

A liquid fuel supply mechanism having a pump for retrieving a liquid fuel stored in an external tank and then supplying the liquid fuel into a fuel cell, and a flow passage for linking the tank to the fuel cell is disclosed. The flow passage includes a first flow passage for supplying the liquid fuel retrieved from the tank into the fuel cell, and a second flow passage for returning a waste fuel after use exhausted out of the fuel cell into the tank. The pump and the first and second flow passages and are mounted altogether on a first sheet member having a film shape to form a single body, which makes possible for the device to be miniaturized and easily handled.

### BACKGROUND OF THE INVENTION

1. Field of the Invention

The present invention relates to a liquid fuel supply mechanism capable of reliably supplying a liquid fuel into a fuel cell and a fuel cell using the liquid fuel supply mechanism.

2. Description of the Related Art

Recently, in view of energy economics and environmental protection, fuel cells have been anticipated as effective energy sources. Owing to remarkable technical progress, fuel cell technology has a longer operating life compared to conventional rechargeable electric cells. This property makes these fuel cells advantages for use in a portable computer (laptop computer), a mobile phone and so on.

In such a fuel cell (not shown), methanol serving as a liquid fuel reacts with a catalyst to make hydrogen, and then this hydrogen is subject to electrochemical reaction with oxygen in the air to generate electricity. The electricity is supplied to the fuel cell.

Further, in order to supply the methanol serving as the liquid fuel into the fuel cell, the fuel cell has a flow passage for supplying the liquid fuel retrieved by a pump into the fuel cell, and another flow passage for returning the spent liquid fuel exhausted from the fuel cell into the tank.

Meanwhile, since these pump and flow passages are discrete components, they are independently assembled and are attached to the fuel cell.

However, according to a conventional liquid fuel supply mechanism disclosed in Japanese Unexamined Patent Application Publication No. 2003-045468, a pump, a supply flow passage, an exhaust flow passage and so on are discrete components and thus are assembled into the fuel cell independently. Thus, even though the fuel cell itself can be miniaturized, it is still difficult to make the size of the whole liquid fuel supply mechanism smaller.

Therefore, when the conventional liquid fuel supply mechanism is employed, the fuel cell becomes inevitably so big as not to be fit for a mobile phone, a notebook computer and the like.

Moreover, it is also cumbersome to assemble the discrete components into one fuel cell separately.

### SUMMARY OF THE INVENTION

Accordingly, the present invention has been made to solve the above-mentioned problems, and it is an object of the present invention to provide a liquid fuel supply mechanism where a pump, a supply passage and an exhaust passage are provided on a single sheet member so as to miniaturize its size and make it easily handled. Further, it is another object of the present invention to provide a fuel cell using the liquid fuel supply mechanism.

[Means for Solving the Problems]

In order to accomplish the above-mentioned objects, according to a first aspect of the present invention, there is provided a liquid fuel supply mechanism comprising a pump for retrieving a liquid fuel stored in an external tank and supplying the liquid fuel to a fuel cell and a passage for linking the tank and the fuel cell. The passage includes a first passage for supplying the liquid fuel retrieved from the tank into the fuel cell and a second passage for returning a waste liquid after use exhausted from the fuel cell into the tank. Here, the pump and the first and second passages are integrated on a first sheet member having a film shape to form a single body.

According to a second aspect of the present invention, a first spacer with a predetermined thickness is formed on the first sheet member, and the first spacer has an elongated slit shaped channel. Here, the first and the second passages are formed by inserting the first spacer, in a sandwich manner, between the first sheet member and a second sheet member formed on the first spacer.

According to a third aspect of the present invention, an inlet opening for retrieving the liquid fuel from the tank and a supply opening for supplying the liquid fuel into the fuel cell are formed on the first flow passage, and an extraction opening for extracting the waste liquid out of the fuel cell and a return opening for returning the extracted liquid fuel into the tank are formed on the second flow passage.

According to a fourth aspect of the present invention, the pump is installed in any one of the first and the second flow passages, and when the pump operates, the liquid fuel retrieved from the tank is supplied into the fuel cell via the supply opening and the waste liquid is exhausted from the fuel cell to the second flow passage via the extraction opening.

According to a fifth aspect of the present invention, a pump chamber of the pump is installed along the first flow passage, a third sheet member having a film shape is formed on the second sheet member, a first valve for preventing the liquid fuel retrieved to the pump chamber from flowing back into the tank is formed on the third sheet member, and a second valve for preventing the liquid fuel supplied into the fuel cell from flowing back into the pump chamber is formed on the second sheet member.

According to a sixth aspect of the present invention, a second spacer of a predetermined thickness is formed between the second and third sheet members, and a first opening which can be closed by the first valve and a second opening which can be closed by the second valve are formed on the second spacer and penetrate the second spacer.

According to a seventh aspect of the present invention, the first valve is formed on the third sheet member in a tongue shape to be elastically deformed, and the second valve is formed on the second sheet member in a tongue shape to be elastically deformed.

According to an eighth aspect of the present invention, the first, the second and the third sheet members and the first and the second spacers are pressed onto a narrow supporting member in a plate shape so as to be firmly in contact with one another.

According to a ninth aspect of the present invention, on a part of the first and/or the second sheet member where the first or the second flow passage is formed, a heating resistor indicating an exothermic property at a predetermined temperature is formed.

According to a tenth aspect of the present invention, the heating resistor is formed by a printing method.

According to an eleventh aspect of the present invention, the heating resistor is supplied with an applied current when the fuel cell begins to operate.

According to a twelfth aspect of the present invention, a fuel cell using the above-mentioned fuel cell supply device is provided, whereby the liquid fuel can be supplied to the fuel cell and the waste liquid can be exhausted into the tank.

According to a thirteenth aspect of the present invention, the fuel cell can be linked to the supply opening and the extraction opening.

According to the liquid fuel supply mechanism of the present invention, since the pump and the first and second flow passages are integrated onto a first sheet member having a film shape to form a single body, it is possible to provide a liquid fuel supply mechanism which can be miniaturized and can be easily handled.

Further, since a first spacer with a predetermined thickness is formed on the first sheet member, an elongated channel having a slit shape is formed on the first spacer, and the first and the second passages are formed by inserting and pressing the first spacer, in a sandwich manner, between the first sheet member and a second sheet member formed on the first spacer, all passages can be formed on the first sheet member, thereby making miniaturization possible.

Further, since the first flow passage has an inlet opening for retrieving the liquid fuel from the tank and a supply opening for supplying the liquid fuel into the fuel cell, and the second flow passage has an extraction opening for extracting the waste liquid out of the fuel cell and a return opening for returning the extracted liquid fuel into the tank, the assembling to the tank and the fuel cell is easy.

Further, since the liquid fuel retrieved from the tank is supplied into the fuel cell via the supply opening and the waste liquid is exhausted from the fuel cell to the second flow passage via the extraction opening when the pump operates, the liquid fuel can be reliably supplied into the fuel cell via the first flow passage and the waste liquid can be reliably returned into the tank via the second passage.

Further, since a first valve for preventing the liquid fuel retrieved to the pump chamber from flowing back into the tank is formed on the third sheet member, and a second valve for preventing the liquid fuel supplied into the fuel cell from flowing back into the pump chamber is formed on the second sheet member, the liquid fuel in the tank can be reliably supplied into the fuel cell by the pump and the reverse flow of the liquid fuel can be effectively prevented.

Further, since a second spacer with a predetermined thickness is arranged between the second and third sheet members, and a first opening which can be closed by the first valve and a second opening which can be closed by the second valve are formed on the second spacer in a manner of penetrating the second spacer respectively, the openings can be closed by the first and the second valves and thus the liquid fuel can be much reliably supplied into the fuel cell without a reverse flow.

Further, since the first valve is formed on the third sheet member in a tongue shape to be elastically deformed, and the second valve is formed on the second sheet member in a tongue shape to be elastically deformed, these first and the second valves can freely close or open the first and the second openings formed on the second spacer.

Further, since the first, the second and the third sheet members and the first and the second spacers are pressed onto a narrow supporting member having a plate shape so that they can firmly be contacted to one another, the first and the second flow passages can be reliably closed so as to prevent the liquid fuel from leaking.

Furthermore, since a heating resistor indicating an exothermic property at a predetermined temperature is formed on the first and/or the second sheet member, it is possible to keep the liquid fuel flowing freely even at a low temperature. Thus, start-up capability of the fuel cell at a low temperature can be improved.

Further, since the heating resistor is formed by a printing method, its manufacturing process is easy.

Further, since the heating resistor is supplied with an applied current when the fuel cell operates, it performs the exothermic reaction only during operation of the fuel cell, thereby reducing power consumption.

Further, since a fuel cell according to the present invention uses the above-mentioned fuel cell supply mechanism, supply of the liquid fuel before use and exhaust of the waste liquid after use to the tank can be smoothly performed and assembly of the pump and the passages onto the fuel cell supply mechanism is also easy.

Furthermore, since the fuel cell according to the present invention can be liked to the supply opening and the extraction opening, assembly of the liquid fuel supply mechanism is simple.

### BRIEF DESCRIPTION OF THE DRAWINGS

FIG. 1 is a perspective view of a liquid fuel supply mechanism according to the present invention;

FIG. 2 is a perspective view on an exploded cross-sectional surface of essential parts in FIG. 1;

FIG. 3 is an exploded perspective view of flow passages according to the present invention;

FIG. 4 is a perspective view on an exploded cross-section surface of essential parts of a pump according to the present invention; and

FIG. 5 is a schematic structure diagram of a liquid fuel supply mechanism according to the present invention.

### DESCRIPTION OF THE PREFERRED EMBODIMENTS

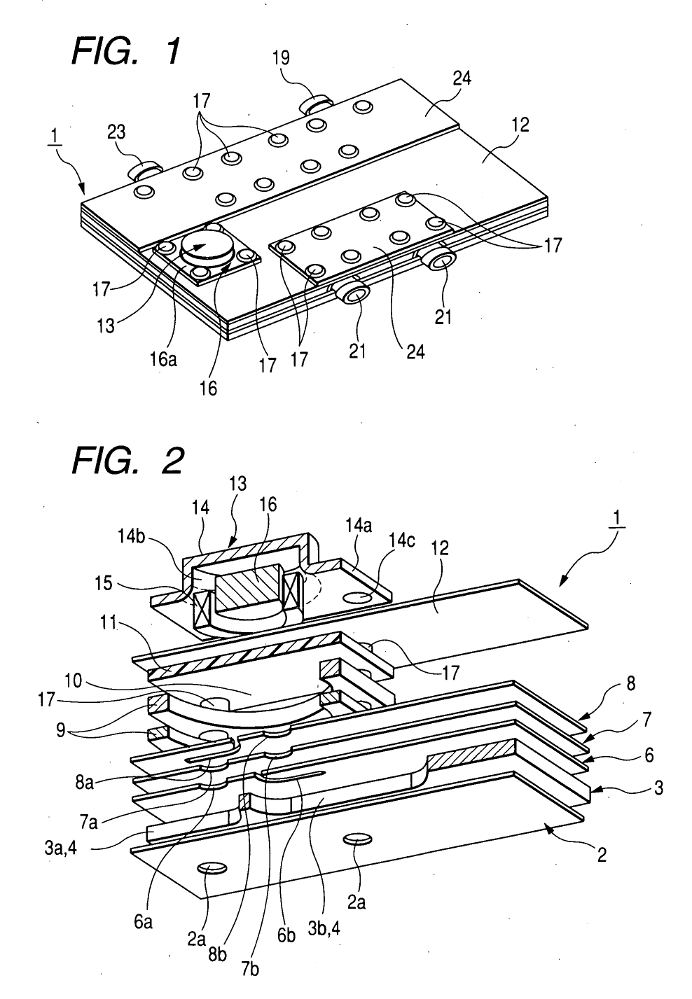

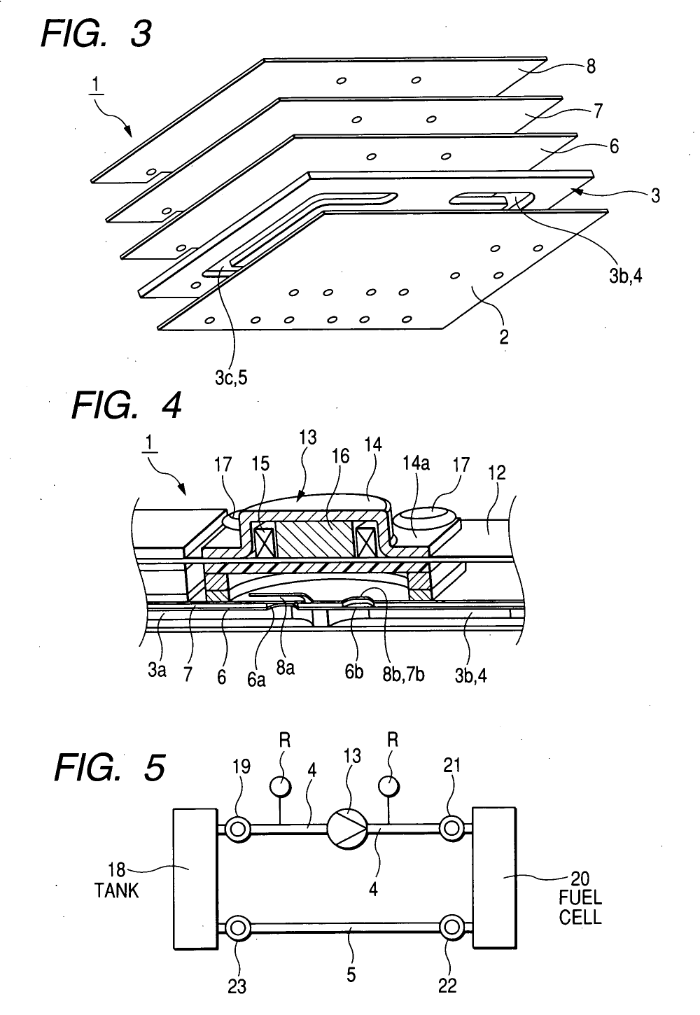

A liquid fuel supply mechanism according to the present invention will be described with reference to FIGS. 1 to 5. FIG. 1 is a perspective view of a liquid fuel supply mechanism according to the present invention, FIG. 2 is a perspective view on an exploded cross-sectional surface of essential parts in the FIG. 1, FIG. 3 is an exploded perspective view of flow passages according to the present invention, FIG. 4 is a perspective view on a cross-section surface of essential parts of a pump according to the present invention, and FIG. 5 is a schematic structure diagram of the liquid fuel supply mechanism according to the present invention.

The liquid fuel supply mechanism 1 according to the present invention, as shown in FIGS. 1 to 4, has a thin film type of first sheet member 2 at the bottom. On the first sheet member 2, supporting holes 2a with a predetermined size are formed at a predetermined pitch.

In addition, on one side (upper side in the drawing) of the first sheet member 2, a first spacer 3 made of a resin material or the like with a predetermined thickness is laminated. A first channel 3a and a second channel 3b each having a strip shape are formed on the first spacer 3, and a first flow passage 4 is formed along the first and second channels 3a and 3b.

In addition, on the first spacer 3, as shown in FIG. 3, a third channel 3c having a slit shape is formed on an area opposite to the area where the first flow passage 4 composed of the first and the second channels 3a and 3b is formed, and a second flow passage 5 is also formed along the third channel 3c.

In addition, a second sheet member 6 of the same thin film type as the first sheet member 2 is laminated onto the first spacer 3. The first spacer 3 is sandwiched between the first and the second sheet members 2 and 6 so that the first and the second channels 3a and 3b are to form the first flow passage 4 and the third channel 3c is to form the second flow passage 5.

In addition, on the second sheet member 6, a hole 6a with a predetermined size is formed on the area where the first channel 3a is located, and a second valve 6b which has a tongue shape and is elastically deformable is formed on the area where the second channel 3b is located.

Moreover, the upper and lower sides of the first spacer 3 are firmly pressed by the first and the second sheet members 2 and 6 using a rivet 19 which is described below, and thus the first, the second and the third channels 3a, 3b and 3c closely contact one another to form the first and the second flow passages 4 and 5.

On the second sheet member 6, a second spacer 7 thicker than the second sheet member 6 is laminated. On the second spacer 7, a first opening 7a that has approximately the same size as the hole 6a is formed at the location facing the hole 6a, and a second opening 7b that has approximately the same size as the first opening 7a is formed at the location facing the second valve 6b of the second sheet member 6.

On the second spacer 7, a third sheet member 8 which has approximately the same thickness as the second sheet member 6 and has a film shape is laminated.

On the third sheet member 8, a first valve 8a which has a tongue shape and is elastically deformable is formed at the location facing the first opening 7a of the second spacer 7, and an opening 8b is formed at the location facing the second opening 7b.

On the third sheet member 8, two pump spacers 9 each having a rectangular shape are laminated at the location facing the first valve 8a and the opening 8b.

Inside the pump spacer 9, a pump chamber 10 sized to encompass the first valve 8a and the opening 8b is formed in an approximately circular shape.

On the pump chamber 10, an elastically deformable diaphragm 11 made of a rubber and the like is arranged to close the pump chamber 10.

On the diaphragm 11, an FPC (flexible substrate) 12 on which a wiring pattern (not shown) is formed is formed and a driving portion of the pump 13 is provided on the pump chamber 10 with the FPC 12 and the diaphragm 11 interposed therebetween.

The driving portion of the pump 13 has a yoke 14 whose outer circumferential portion is made of a magnetic material. The yoke 14 has a flange portion 14a in a rectangular shape and a concave 14b formed at the center of the flange portion 14a. By protruding the central portion of the flange portion 14a upward in the drawing, the concave 14b is formed such that it has a predetermined height. In addition, supporting holes 14c are formed at four corners of the flange portion 14a.

Further, inside of the concave 14b, a hollow coil 15 is installed and the coil 15 adheres to a fourth sheet member 14 by an adhesive. In the hollow inside of the coil 15, a magnet 16 made of a permanent magnet is installed and this magnet 16 is fixed to the ceiling of the concave 14b formed at the inside of the yoke 14 by an adhesive and the like.

Under this structure, when an alternating current with a predetermined frequency is applied to the coil 15, a magnetic flux is generated and this magnetic flux exerts an influence on the magnetic flux of the magnet 16 to make the coil 15 vibrate up and down. As a result, the FPC 12 and the diaphragm 11 vibrate so that the pump chamber 10 is subject to contraction or expansion.

The flange portion 14a of the yoke 14 of the pump 13 serves as a narrow supporting member for the upper side. A rod-shaped rivet 17 is inserted into the supporting hole 14c so as to penetrate the supporting holes (not shown) respectively formed in the FPC 12, the pump spacer 9, the third sheet member 8, the second spacer 7, the second sheet member 6 and the first spacer 3 such that the end projects by a predetermined length from the supporting hole 2a formed in the first sheet member 2.

In addition, as shown in FIG. 1, parts other than the pump 13 are covered with a plate-shaped supporting member 24 and a plurality of rivets 17 are inserted into the narrow supporting member 24.

On the bottom of the first sheet member 2, a narrow supporting member (not shown) for the bottom side that has a plate shape and is made of a metal plate is arranged. By tightening up the projected ends of the rivet 17 passing through the supporting hole 14c formed on the flange portion 14a of the narrow supporting member 24 for the upper side onto the narrow supporting member for the bottom side, the first and the second flow passages 4 and 5 and the pump chamber 10 become closed.

When the narrow supporting member 24 for the upper side mounted on an inlet opening 19, an exhaust opening 23, the supply opening 21 and the extraction opening 22 is tightened up, each flow passage linked to the inlet opening 19, the exhaust opening 23, the supply opening 21 and the extraction opening 22 becomes closed. Thus, it is possible to prevent the liquid fuel that is intended to flow into the flow passages 4 and 5 or the pump chamber 10 from leaking to the outside.

As shown in FIG. 5, on the first flow passage 4, an inlet opening 19 for retrieving the liquid fuel (not shown) made of methanol stored in an external tank 18 and a supply opening 21 for supplying the retrieved liquid fuel into the fuel cell 20 are formed. Similarly, on the second flow passage 5, an extraction opening 22 for extracting a waste liquid after use of the liquid fuel from the fuel cell 20 and an exhaust opening 23 for exhausting the extracted waste liquid and then returning it to the tank 18 are formed.

Moreover, on the first sheet member 2 constituting the first flow passage 4 or the second sheet member 6 constituting the second flow passage 5, or on both external surfaces of the first and the second sheet members 2 and 6, a heating resistor R capable of generating heat at a predetermined temperature by supplying a current is formed by the means of printing and the like.

That is, the heating resistor R can be formed on the first sheet member 2 and/or the second sheet member 6.

The heating resistor R is designed to be supplied with a current to generate heat at a predetermined temperature when the pump 13 operates and thus the liquid fuel begins to be supplied into the fuel cell 20. When the surrounding temperature is lower than the predetermined temperature, the first flow passage 4 is heated so as to heat the liquid fuel in the first flow passage 4.

Thus, at even low temperature, the fluidity of the liquid fuel can be kept good and the start-up capability of the fuel cell 20 can be improved as well.

Since the above-mentioned liquid fuel supply mechanism 1 according to the present invention has such a structure that the first and second flow passages 4 and 5 and the pump 13 are integrally arranged on a piece of the first sheet member 2, and thus peripheral components for supplying the liquid fuel into the fuel cell 20 are integrated into a single body, miniaturization is realizable.

In addition, the tank 18 that can be mounted onto the liquid fuel supply mechanism 1 according to the present invention has a fuel chamber for storing the liquid fuel and a waste liquid chamber for storing the waste liquid exhausted from the fuel cell 20, which are formed therein.

In addition, when the tank 18 is mounted onto the liquid fuel supply mechanism 1 according to the present invention, the fuel chamber is linked to the inlet opening 19 and the waste liquid chamber is linked to the exhaust opening 23.

In addition, the supply opening 21 and the extraction opening 22 of the liquid fuel supply mechanism 1 according to the present invention are linked to the fuel cell 20.

Hereinafter, the operation of the liquid fuel supply mechanism 1 assembled with the tank 18 and the fuel cell 20 will be described. When an alternating current with a predetermined frequency is applied to the coil 15 of the pump 13 by using an external switch (not shown), a magnetic flux generated from the coil 15 exerts an influence on the magnetic flux of the magnet 16 to make the coil 15 vibrate up and down.

Here, when the vibrating coil 15 moves upward as shown in FIG. 4, the pump chamber 10 disposed under the coil 15 with the FPC 12 and the diaphragm 11 interposed therebetween undergoes expansion and its internal pressure decreases.

When the pump chamber 10 expands, the first valve 8a having a tongue shape undergoes elastic deformation towards the pump chamber 10. Then, the liquid fuel stored in the tank 18 is supplied into the pump chamber 10 from the inlet opening 19 via the first channel 3a constituting the first flow passage 4, the hole 6a on the second sheet member 6 and the first opening 7a on the second spacer 7.

After that, when the current is applied to the coil 15 in a reverse direction, the coil 15 moves downward and the pump chamber 10 undergoes contraction. When the pump chamber 10 contracts and its internal pressure increases, the liquid fuel put a pressure onto the second valve 6b via the hole 8b in the third sheet member 8 and the second opening 7b on the second spacer 7 and the second valve 6b undergoes the elastic deformation downward.

In this result, the liquid fuel retrieved to the pump chamber 10 is pushed out towards the second channel 3b.

In this way, the coil 15 repeatedly vibrates to cause expansion and contraction of the pump chamber 10 repeatedly, so that the liquid fuel is supplied into a stack cell, composed of a plurality of cell layers, in the fuel cell 20 via the supply opening 21 to generate electricity with a predetermined voltage.

In addition, the waste liquid, that is, the liquid fuel remaining after generating electricity, is pushed out by the liquid fuel supplied from the supply opening 21 to be exhausted to the second flow 5 via the extraction opening 22.

The waste liquid exhausted to the second flow passage 5 returns to the waste liquid chamber (not shown) of the tank 18 via the exhaust opening 23. As the liquid fuel in the storage chamber is depleted, the waste liquid chamber of the tank 18 becomes enlarged while the storage chamber becomes smaller.

Thus, all the exhausted waste liquid can be stored in the waste liquid chamber.

Even though the above-mentioned embodiment of the present invention discloses a structure that the second sheet member 6 and the third sheet member 8 are laminated with the second spacer 7 interposed therebetween, the structure may also applicable to a case in which the second sheet member 6 and the third sheet member 8 are directly laminated on each other without the second spacer 7 interposed therebetween.

In this case, the first valve 8a is supposed to directly close the hole 6a formed on the second sheet member 6 and the second valve 6b may be intended to directly close the hole 8b formed on the third sheet member 8.

In addition, even though the above-mentioned embodiment describes a structure that the pump 13 is installed on the first flow passage 4, the pump 13 may be also installed on the second flow passage 5.

That is, the pump 13 can be installed in any one of the first flow passage 4 and the second flow passage 5, by driving the pump 13, the liquid fuel retrieved from the tank 18 can be reliably supplied into the fuel cell 20 via the supply opening 21 and the waste liquid exhausted from the fuel cell 20 can be exhausted to the second flow passage 5 via the extraction opening 22. coil 15 adheres to a fourth sheet member 14 by an adhesive. In the hollow inside of the coil 15, a magnet 16 made of a permanent magnet is installed and this magnet 16 is fixed to the ceiling of the concavity 14b formed at the inside of the yoke 14 by an adhesive and the like.

1. A liquid fuel supply mechanism comprising a pump for retrieving a liquid fuel stored in an external tank and supplying the liquid fuel into a fuel cell, and a flow passage for linking the tank to the fuel cell,
wherein the flow passage includes a first flow passage for supplying the liquid fuel retrieved from the tank into the fuel cell, and a second flow passage for returning a waste liquid after use exhausted out of the fuel cell into the tank, and
the pump and the first and second flow passages are provided in a first sheet member having a film shape to form a single body.

2. The liquid fuel supply mechanism according to claim 1,
wherein an elongated slit shaped channel is formed in a first spacer having a predetermined thickness formed on the first sheet member, and
the first and the second flow passages are formed by inserting and pressing the first spacer, in a sandwich manner, between the first sheet member and a second sheet member formed on the first spacer.

3. The liquid fuel supply mechanism according to claim 1,
wherein the first flow passage includes an inlet opening for retrieving the liquid fuel from the tank, and a supply opening for supplying the liquid fuel into the fuel cell, and
the second flow passage includes an extraction opening for extracting the waste liquid from the fuel cell, and a return opening for returning the extracted liquid fuel into the tank.

4. The liquid fuel supply mechanism according to claim 3,
wherein the pump is installed in any one of the first and second flow passages, and
when the pump operates, the liquid fuel retrieved from the tank is supplied into the fuel cell via the supply opening, and the waste liquid is exhausted from the fuel cell into the second flow passage via the extraction opening.

5. The liquid fuel supply mechanism according to claim 2,
wherein a pump chamber of the pump is installed along the first flow passage,
a third sheet member having a film shape is arranged on the second sheet member,
a first valve for preventing the liquid fuel retrieved to the pump chamber from flowing back into the tank is formed on the third sheet member, and
a second valve for preventing the liquid fuel supplied into the fuel cell from flowing back into the pump chamber is formed on the second sheet member.

6. The liquid fuel supply mechanism according to claim 5,
wherein a second spacer with a predetermined thickness is formed between the second and third sheet members, and
a first opening which is closed by the first valve and a second opening which is closed by the second valve are formed on the second spacer and penetrate the second spacer.

7. The liquid fuel supply mechanism according to claim 6,
wherein the first valve is formed on the third sheet member in a tongue shape so as to be elastically deformed, and
the second valve is formed on the second sheet member in a tongue shape so as to be elastically deformed.

8. The liquid fuel supply mechanism according to claim 6,
wherein the first, the second and the third sheet members and the first and the second spacers are pressed by a narrow supporting member having a plate shape so as to be firmly in contact with one another.

9. The liquid fuel supply mechanism according to claim 2,
wherein on a part of at least one of the first and second sheet member where the first or second flow passage is formed, a heating resistor indicating an exothermic property at a predetermined temperature is installed.

10. The liquid fuel supply mechanism according to claim 9,
wherein the heating resistor is formed by a printing method.

11. The liquid fuel supply mechanism according to claim 9,
wherein the heating resistor is supplied with an applied current when the fuel cell begins to operate.

12. A fuel cell using the liquid fuel supply mechanism according to claim 1,
wherein the liquid fuel can be supplied to the fuel cell and the waste liquid can be exhausted into the tank.

13. A fuel cell which can be linked to the supply opening and the extraction opening according to claim 3.
